(19) United States
(12) Patent Application Publication
(10) Pub. No.: US 2008/0033134 A1
(43) Pub. Date: Feb. 7, 2008

(54) Norbornene-based polymer film, and retardation film, polarizing plate and liquid crystal display device using a polymer film

(75) Inventor: Saisuke WATANABE, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/878,742

(22) Filed: Jul. 26, 2007

(30) Foreign Application Priority Data
Jul. 28, 2006 (JP) 2006-206118

(51) Int. Cl. C08F 10/00

(52) U.S. Cl. 526/280

(57) ABSTRACT

A film comprising norbornene-based polymer has a repeating unit represented by the following formula (1): 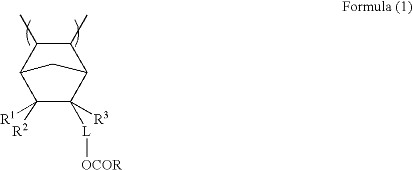
wherein L represents a single bond or an alkylene group having 1 to 10 carbon atoms, R represents alkyl group having 2 to 10 carbon atoms, R¹, R² and R³ each represent a hydrogen atom or a substituent group.

### FIELD OF THE INVENTION

The present invention relates to films (particularly, various kinds of functional films such as retardation films, viewing angle-widening films and antireflection films to be used in plasma displays, polarization plate-protecting films, etc.) and polarization plates using a norbornene-based polymers.

### BACKGROUND OF THE INVENTION

Since a film of a norbornene-based polymer obtained by a vinyl polymerization of a norbornene-based compound is feature by a high retardation value in a thickness direction (Rth), it is applicable to a negative C-plate (WO/2004/049011). Further, when the film is stretched, main chains of the norbornene-based polymer are oriented in the stretched direction, and retardation (Re) is exhibited. Thus, the film can be used for biaxial retardation plates. That is, the films of the norbornene-based polymer are promising as the retardation films having high Re and Rth values.

Particularly, since films of norbornene-based polymers having polar groups such as acyl groups possess moisture permeability in addition to appearance of the high Re and Rth values, they can be expected to have high bondability characteristic to polarizing plates.

### SUMMARY OF THE INVENTION

The WO/2004/049011 describes norbornene-based polymers having acetyl groups as the norbornene-based polymers having the acyl groups. However, inventors' investigations revealed that such norbornene-based polymers have high glass transition temperatures of 300° C. or more.

In general, in order to make an optical film exhibit retardation, the film needs to be stretched at not less than the glass transition temperature. Therefore, the above-mentioned films need be stretched at not less than 300° C. However, it was revealed that it was not only industrially difficult to stretch the film at not less than 300° C., but also there occurred problems of deteriorations of the film, for example, the film changed yellowish.

When the film was stretched at not more than its glass transition temperature (for example, 200 to 300° C.), there occurred problems that the elongation at break was small and sufficiently large retardation was not exhibited.

On the other hand, there is a tendency that films having small retardations are also sought as polarization plate-protecting films, etc.

It is an object of the present invention to provide a film which can be stretched at an industrially appropriate temperature and can exhibit retardation in a wide range.

In order to solve the above problems, the present inventors have tried to reduce the glass transition temperatures of polymers of norbornene-based compounds containing acyl groups by molecular designing. As a result, it was found that the glass transition temperatures of the norbornene-based polymers were reduced by increasing the number of carbon atoms of alkyl groups included in the acyl groups and further that an elongation at break of the film increased contrary to the expectation. Further, it was revealed that this approach could be applied not only to homopolymers but also to copolymers.

That is, the inventors succeeded in developing large or small retardation of the norbornene-based polymers, at an industrially stretchable temperature, which have been heretofore difficult to be stretched.

The measures to solve the above problems are as follows.
(1) A film comprising norbornene-based polymer having a repeating unit represented by the following formula (1): 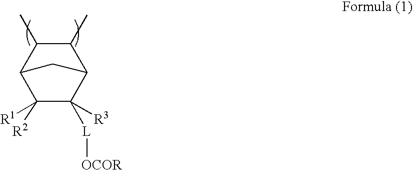
   wherein L represents a single bond or an alkylene group having 1 to 10 carbon atoms, R represents alkyl group having 2 to 10 carbon atoms, R¹, R² and R³ each represent a hydrogen atom or a substituent group.
(2) The film according to (1), wherein L is a single bond or a methylene group (—CH₂—).
(3) The film according to (1) or (2), wherein R is an alkyl group having 3 to 6 carbon atoms.
(4) The film according to any one of (1) to (3), at least one of R¹, R² and R³ is a hydrogen atom.
(5) The film according to any one of (1) to (4), all of R¹, R² and R³ are a hydrogen atom.
(6) The film according to any one of (1) to (5), the norbornene-based polymer is a homopolymer.
(7) The film according to any one of (1) to (6), the number average molecular weight of the norbornene-based polymer is 10,000 to 1,000,000.
(8) A retardation film comprising the film according to any one of (1) to (7).
(9) The retardation film according to (8), which meets the following formula (1):
   0≦Re≦400 nm (1)
   wherein Re represents a retardation (Re) values at wavelengths of 590 nm.
(10) A polarizing plate comprising a polarizer and the film according to any one of (1) to (7).
(11) A Liquid crystal display comprising the film according to any one of (1) to (7).

### DESCRIPTION OF SPECIFIC EMBODIMENTS

In the following, embodiments of the present invention will be explained in more detail. In the present specification, “- - - to - - - ” is used to mean that figures recited before and after “to” are included as a lower limit and an upper limit.

[Norbornene-Based Polymer]

The norbornene-based polymer of the present invention is characterized by having a repeating unit represented by the following formula (1).

The norbornene-based polymers in the present invention include homopolymers and copolymers in which norbornene-based compounds are polymerized (for example, addition polymerized). 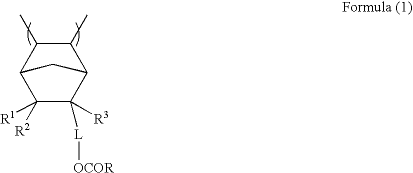
wherein L represents a single bond or an alkylene group having 1 to 10 carbon atoms, R represents an alkyl group having 2 to 10 carbon atoms, and R¹, R² and R³ each represent a hydrogen atom or a substituent group.

L represents a single bond or an alkylene group having 1 to 10 carbon atoms. Herein, the alkylene group having one carbon atom represents —CH₂—. The shorter the L is, the smaller is the optical elasticity. Since this tendency is preferable for the film, L is preferably a single bond or an alkylene group having 1 to 5 carbon atoms, more preferably a single bond or an alkylene group having 1 or 2 carbon atoms, and further preferably a single bond or a methylene group.

The glass transition temperature of the norbornene-based polymer in the present invention can be varied depending upon the number of carbon atoms of R.

It is ideal to stretch the film according to the present invention at not more than 250° C., and concretely it is preferably to stretch the film at 100 to 250° C. Therefore, the glass transition temperature of the film of the present invention is preferably not less than 100° C., more preferably 100 to 250° C., and further preferably 130 to 250° C.

R is preferably an alkyl group having 3 to 6 carbon atoms, and more preferably an alkyl group having 3 to 5 carbon atoms. Although the alkyl group may possess a substituent group, a non-substituted alkyl group is preferable.

R¹, R² and R³ each represent a hydrogen atom or a substituent group, and hydrogen atom, an alkyl group, an aryl group, an acyl group, an ester group and an L-OCOR, wherein L and R represent the same meanings as mentioned above, are preferable, and hydrogen atom is further preferable.

The norbornene-based polymer to be used in the present invention may be a homopolymer consisting only of the repeating unit represented by the formula (1) or a copolymer with other repeating unit (preferably a repeating unit derived from a norbornene-based monomer). The homopolymer consisting only of the repeating unit represented by the formula (1) in the present invention may use plural kinds of the repeating units represented by the formula (1). In this case, “consisting only of” in the present invention does not exclude cases in which other component such as an impurity, a residue or the like is contained in such an amount as not negating the purpose of the present invention.

As the copolymer, a norbornene-based polymer containing at least one kind of the repeating unit represented by the formula (1) and at least one kind of a repeating unit represented by a formula (2) is recited, for example. 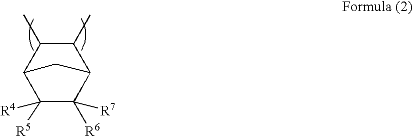
R⁴, R⁵, R⁶ and R⁷ each represent a hydrogen atom or a substituent group, or may be bonded together to form a ring. R⁴, R⁵, R⁶ and R⁷ are each preferably a hydrogen atom, an alkyl group, an aryl group, an acyl group, an ester group, an L-OCOR, wherein L and R represent the same meanings as above, and hydrogen atom, the alkyl group or the aryl group is more preferably, and hydrogen atom or the aryl group is further preferable.

In the case of the norbornene-based polymer containing the repeated unit represented by the formula (1) and the repeating unit represented by the formula (2), the percentage of the repeating unit represented by the formula (1) is preferably not less than 50 mol %, more preferably not less than 60 mol %, and further preferably not less than 70 mol %. In the case of the norbornene-based polymer containing the repeating unit represented by the formula (1) and other arbitrary repeating unit, preferable ranges similar to the above can be recited.

The norbornene-based polymer in the present invention has the number average molecular weight on polystyrene conversion of preferably 10,000 to 1,000,000, and more preferably 50,000 to 500,000 when measured by a gel-permeation chromatogram using tetrahydrofuran as a solvent. On the other hand, the polymer has the weight average molecular weight on polystyrene conversion of preferably 15,000 to 1,500,000, and more preferably 70,000 to 700,000. When the number average molecular weight on polystyrene conversion is set to not less than 10,000 or the weight average molecular weight on polystyrene conversion is set to not less than 15,000, the breaking strength tends to increase. On the other hand, when the number average molecular weight on polystyrene conversion is set to not more than 1,000,000 or the weight average molecular weight on polystyrene conversion set to not more than 1,500,000, there are tendencies that moldability of sheets is improved and that when a cast film or the like is to be formed, the viscosity of a solution does not become too high, and so the polymer is easily handled.

The molecular weight distribution (weight average molecular weight/number average molecular weight) is preferably 1.1 to 6.0, more preferably 1.1 to 5.0, and further preferably 1.1 to 4.5. When the molecular weight distribution of the norbornene-based polymer is set in the above range, it is likely that the solution of the norbornene-based polymer (dope) becomes homogeneous, which easily form a better film.

The norbornene-based polymer of the present invention may be produced by the following method.

As a catalyst, (1) [Pd(CH₃CN)₄][BF₄]₂, (2) di-μ-chloro-bis-(6-methoxybicyclo[2.2.1]hepto-2-ene-end-5σ,2π)-Pd (hereinafter briefly referred to as [I]) and methyl alumoxane (MAO), (3) I and AgBF₄, (4) I and AgSbF₆, (5) [(η³-allyl)PdCl]₂ and AgSbF₆, (6) [(η³-allyl)PdCl]₂ and AgBF₄, (7) [(η³-crotyl)Pd(cyclooctadiene)[PF₆], (8) [(η³-allyl)Pd[(η⁵-cyclopentadienyl)₂, tricyclohexylphosphine and dimethyl anilinium tetrakispentafluorophenyl borate or trityltetrakispentafluorophenyl borate, (9) palladium bis(acetylacetonato), tricyclohexyl phosphine and dimethyl anilinium tetrakispentafluorophenyl borate, (10) [(η³-allyl)PdCl]₂, tricyclohexyl phosphine and tributylallyl tin or allyl magnesium chloride and dimethyl anilinium tetrakispentafluorophenyl borate, (11) palladium acetate or palladium bis(acetylacetonato) and tricyclohexyl phosphonium tetrakispentafluorophenyl borate (HP(C₆H₁₁)₃B(C₆F₅)₄), (12) [(η⁵-cyclopentadienyl)Ni(methyl)(triphenylphosphine) and trispentafluorophenyl borane, (13) [(η³-crotyl)Ni(cyclooctadiene)][B((CF₃)₂C₆H₄)₄], (14) [NiBr(NPMe₃)]₄ and MAO, (15) Ni(octoate)₂ and MAO, (16) Ni(octoate)₂, B(C₆F₅)₃ and AlEt₃, (17) Ni(octoate)₂, [ph₃C][B(C₆F₅)₄] and Ali-Bu₃, or (18) Co(neodecanoate) and a cation complex of MAO or the like and Ni, Pd, Co or the like in Periodic Table VIII or a catalyst forming such a cation complex is used. The norbornene-based polymer of the present invention can be obtained by homopolymerizing a monomer or copolymerizing monomers in a solvent in a range of 20 to 150° C. by using the above catalyst:

The solvent can be selected from alicyclic hydrocarbon solvents such as cyclohexane, cyclopentane, methylcyclopentane, etc.; aliphatic hydrocarbons solvents such as pentane, hexane, heptane, octane, etc.; aromatic hydrocarbon solvents such as toluene, benzene, xylene, etc.; halogenated hydrocarbon solvents such as dichloromethane, 1,2-dichloroethylene, chlorobenzene, etc.; and polar solvents such as ethyl acetate, butyl acetate, γ-butylolactone, propylene glycol dimethyl ether, nitromethane, etc. Further, as other synthesis methods, methods described in Macromolecules, 1996, Vol. 29, page 2755, Macromolecules, 2002, Vol. 35, page 8969 and WO/2004/7564 are favorably used.

The norbornene-based homopolymer having the repeating unit represented by the formula (1), and the norbornene-based homo-/co-polymer having the repeating unit represented by the formula (1) and the repeating unit represented by the formula (2) can be generally synthesized as follows.

That is, a norbornene-based compound is obtained by a Diels-Alder reaction between corresponding olefin and cyclopentadiene (obtained by thermally decomposing dicyclopentadiene). The polymer is obtained from this compound with use of the above-mentioned catalyst. 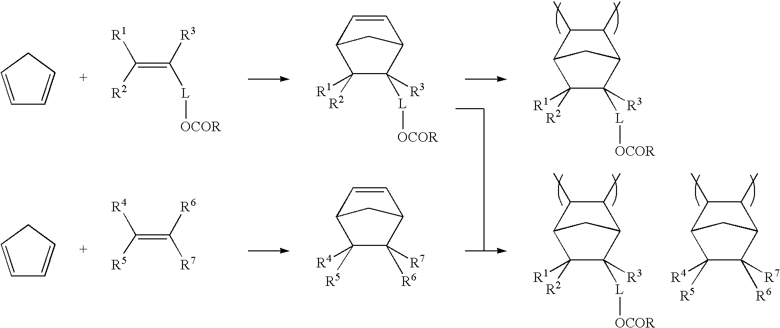
wherein L, R, R¹, R² and R³ represent the same meanings given in the formula (1), respectively, and R⁴, R⁵, R⁶ and R⁷ represent the same meanings given in the formula (2).

Although examples of the norbornene-based polymers in the present invention are shown below, the invention is not limited to them. 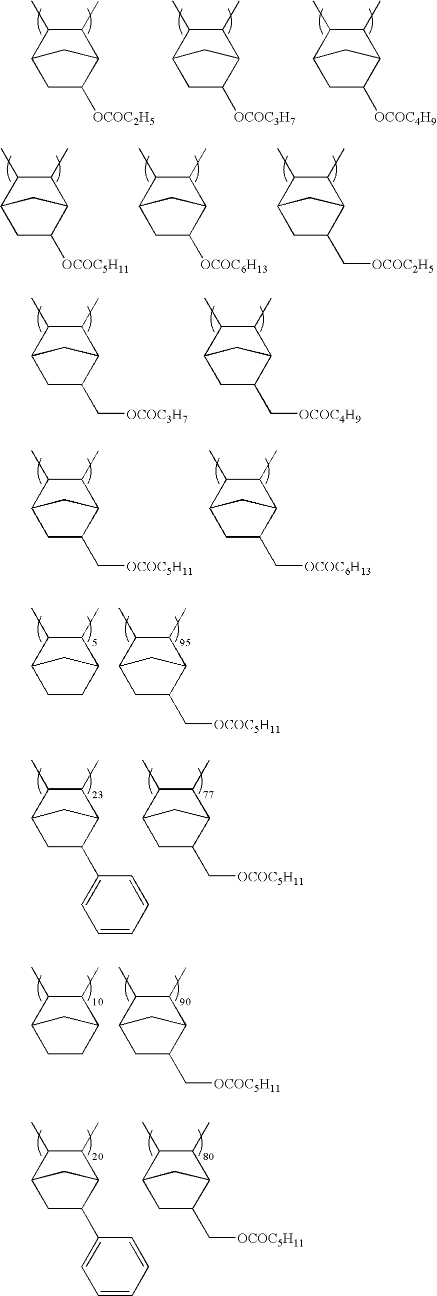
[Films of Norbornene-Based Polymers]

The films according to the present invention can be favorably used as films for optical applications, including substrates of liquid crystal display elements, light guide plates, polarizing films, retardation films, liquid crystal back lights, liquid crystal panels, OHP films, transparent electroconductive films, etc. The norbornene-based polymers represented by the above formula (1) are favorably used as optical materials for optical discs, optical fibers, lenses, prisms, etc., electronic parts, medical instruments, containers, etc.

[Method for Producing Films of Norbornene-Based Films]

The film of the present invention comprises a norbornene-based polymer containing the repeating units represented by the above formula (I), and can be produced by forming a film with the this polymer as a raw material. For the formation of the film, a thermal fusion film-forming method and a solution film forming method are exemplified, and any of them is applicable. In the present invention, it is preferable to use the solution film-forming method, which can produce a film having an excellent surface. In the following, the solution film-forming method will be explained.

(Solution Film-Forming Method)

(Preparation of a Dope)

First, a solution (dope) of the above polymer to be used in film forming is prepared. An organic solvent to be used in the preparation of the dope is not particularly limited, so long as dissolving, flow casting and film forming are possible and the purposes thereof can be attained. A solvent is preferable, which is selected from chlorine-based solvents represented by dichloromethane and chloroform, straight-chain hydrocarbons having 3 to 12 carbon atoms (hexane, octane, isooctane, decane, etc.), cyclic hydrocarbons (cyclopentane, cyclohexane, decalin, etc.), aromatic hydrocarbons (benzene, toluene, xylene, etc.), esters (ethyl formate, propyl formate, pentyl formate, methyl acetate, ethyl acetate, pentyl acetate, etc.), ketones (acetone, methylethyl ketone, diethyl ketone, diisobutyl ketone, cyclopentanone, cyclohexanone, methyl cyclohexanone, etc.), ethers (diisopropyl ether, dimethoxy methane, dimethoxy ethane, 1,4-dioxane, 1,3-dioxorane, tetrahydrofuran, anisole, phenetol, etc.). As examples of organic solvents having two or more functional groups, 2-ethoxyethyl acetate, 2-methoxyethanol and 2-butoxyethanol are recited. Preferred boiling points of the organic solvents are 35° C. to not more than 200° C. As to the solvents to be used for the preparation of the above solution, a mixture of two or more kinds of the solvents can be used to adjust physical properties of the solvents, such as a drying property, viscosity, etc. Further, a poor solvent can be added, so long as it is solved in a mixed solvent.

A preferable poor solvent can be appropriately selected. When a chlorine-based organic solvent is used as a good solvent, an alcohol can be favorably used. The alcohols may be preferably linear, branched or cyclic. Among them, a saturated aliphatic hydrocarbon is preferable. The hydroxyl groups of the alcohols may be any of primary to tertiary. Further, fluorine-based alcohols are used as the alcohols. For example, 2-fluoroethanol, 2,2,2-trifluoroethanol, 2,2,3,3-tetrafluoro-1-propanol, etc. are recited. Among the poor solvents, monovalent alcohols are preferably used, because they particularly have a peeling resistance-reducing effect. Particularly preferable alcohols change depending upon the good solvent selected, but considering a drying load, preferably alcohols having boiling points of not more than 120° C., more preferably monovalent alcohols having 1 to 6 carbon atoms, and particularly preferably alcohols having 1 to 4 carbon atoms can be used.

A mixed solvent particularly preferable in preparing the dope is a combination of dichloromethane as a main solvent and one or more kinds selected from methanol, ethanol, propanol, isopropanol and butanol as a poor solvent.

In order to prepare the above dope, there are available a method in which dissolution is effected under stirring at room temperature, a cooling/dissolving method in which the polymer is swollen under stirring at room temperature, then cooled to −20° C. to −100° C. and dissolved by heating it to 20° C. to 100° C. again, a high temperature dissolving method in which the polymer is dissolved in a sealed container by raising the temperature to at least the boiling point of the main solvent, a method in which the polymer is dissolved by subjecting it to a high temperature and a high pressure up to a critical point of the solvent, etc. The viscosity of the dope is preferably in a range of 1 to 500 Pa·s, more preferably in a range of 5 to 200 Pa·s, at 25° C. The viscosity is measured as follows. A sample solution 1 mL is placed in a steel cone with a diameter of 4 cm/2°, which is placed in a rheometer (CLS500) (Both of the steel cone and the rheometer are manufactured by TA Instruments Co., Ltd.). After the sample solution is preliminarily kept at a measurement-starting temperature until the liquid temperature becomes constant, the measurement is started.

It is preferable that foreign matters such as a non-dissolved matter, dirt, impurities, etc. are filtered off from the solution using an appropriate filtering medium such as a metal net or a flannel before flow casing. The viscosity of the solution immediately before film forming may be in a range which enables flow casting in the film formation, and is adjusted preferably in a range of 5 Pa·s to 1000 Pa·s, more preferably in a range of 15 Pa·s to 500 Pa·s, and further preferably in a range of 30 Pa·s to 200 Pa·s. The temperature at that time is not particularly limited, so long as it is the temperature at the time of the flow casting. The temperature is preferably −5 to 70° C., and more preferably −5 to 35° C.,

(Additives)

The films of the present invention may contain additives having no relation to the production of the above norbornene-based polymer in such a range as not negating the purpose of the present invention. Such additives may be added in any stage in a process for producing the film according to the present invention. The additives can be selected depending upon uses. For example, a degradation-preventing agent, an ultraviolet rays protective agent, a retardation (optical anisotropy) adjusting agent, fine particles, a peeling accelerating agent, an infrared absorber, etc. are recited. These additives may be solid or oily. When the film is produced by the solution flow casting method, the additives may be added at any time during the dope-preparing process. Alternatively, the additives may be added at a finally adjusting step in the process of preparing the dope. When the film is produced by the melting method, the additives may be added at the time of preparing the resin pellets, or may be kneaded at the time of producing the film. An addition amount of each of the additives is not particularly limited, so long as the function is exhibited. When the film is constituted by plural layers, the kinds and addition amounts of the additives in the respective layers may differ.

The degradation-(oxidation-) preventing agent is preferably used from the standpoint of preventing the degradation of the film. For example, a phenol-based or hydroquinone-based antioxidant such as 2,6-di-tert-butyl, 4-methyl phenol, 4,4′-thiobis-(6-tert-butyl-3-methyl phenol), penthaerythritol-tetrakis[3-(3,5-di-tert-butyl-4-hydroxy phenyl)propionate or the like can be added. Further, it is preferable to add a phosphorus-based antioxidant such as tris(4-methoxy-3,5-diphenyl)phosphite, tris(nonylphenyl)phosphite, bis(2,4-di-tert-butylphenyl)pentaerythritol diphosphite or the like. The antioxidant is added in an amount of 0.05 to 5.0 parts by mass relative to 100 parts by mass of the polymer.

From the standpoint of preventing the degradation of the polarizing plate, the liquid crystals and the like, the ultraviolet absorbing agent is preferably used. From the standpoint of excellent ultraviolet absorbing capability in a wavelength range of not more than 370 nm and good liquid crystal displaying characteristics, the ultraviolet absorbing agent having less absorption of visible lights having wavelengths in a range of 400 nm or more is preferably used. As specific examples of the ultraviolet absorbing agent to be preferably used in the present invention, mention may be made of, for example, a hindered phenol-based compound, an oxybenzophenone-based compound, a benzotriazole-based compound, a salicylic acid ester-based compound, a benzophenone-based compound, a cyanoacrylate-based compound, a nickel complex-based salt, etc. The addition amount of the ultraviolet rays preventing agent is preferably 1 ppm to 1.0%, more preferably 10 to 1000 ppm with respect to the norbornene-based polymer in terms of mass ratio.

In order to improve a slipping property of the film surface, fine particles (a matting agent) are preferably used. When this agent is used, unevenness is given to the surface of the film, that is, roughness of the surface of the film is raised (matted), so that the films can be prevented from being blocked together. When the fine particles are present in the films or on at least one surface of the film, adhesion between a polarizing film and the film at the time of processing the polarizing plate is remarkably improved. The matting agent to be used in the present invention consists of fine particles having the average particle size of, for example, 0.05 μn to 0.5 μm, preferably 0.08 μm to 0.3 μm, and more preferably 0.1 μm to 0.25 μm in the case of fine inorganic particles. As to the fine particles, silicon dioxide, silicon, and titanium dioxide are preferable as the inorganic compound, whereas a fluorine resin, nylon, propylene and chlorinated polyether are preferable as polymer compounds. Among them, silicon dioxide is more preferable, and silicon dioxide having the surface treated with an organic material is further preferable.

In order to reduce the peeling resistance of the film, a peeling accelerator is preferably used. As preferable peeling agent, a phosphoric acid ester-based surface active agent, a carboxylic acid-based or carboxylic acid salt-based surface active agent, a sulfonic acid-based or sulfonic acid salt-based surface active agent, and a sulfuric acid ester-based surface active agent are effective. Fluorine-based surface active agents in which a part of hydrogen atom(s) bonded to hydrocarbon chain of each of the above surface active agents is replaced by fluorine atom(s) is also effective. The addition amount of the peeling agent is preferably 0.05 to 5 mass %, more preferably 0.1 to 2 mass %, and further preferably 0.1 to 0.5 mass % with respect to the norbornene-based polymer.

(Production of Films)

As a method and an apparatus for producing the films of the present invention, a solution flow casting/film-producing method and a solution flow casting/film-producing apparatus similar as served in the production of publicly known cellulose triacetate films are preferably used. Once a dope prepared in a dissolving machine (kettle) is stored in a storing kettle, foams contained in the dope are removed to prepare a final dope.

Cellulose acylate film-producing techniques described in JP-A 2000-301555, JP-A 2000-301558, JP-A H07-032391, JP-A H03-193316, JP-A H05-086212, JP-A S62-037113, JP-A H02-276607, JP-A S55-014201, JP-A H02-111511 and JP-A H02-208650 can be preferably used in the present invention.

(Flow Casting of Multiple Layers)

A dope may be flow cast on a flat and smooth band or drum as a metallic support in the form of a single layer liquid or two or more layers of plural dopes may be flow cast thereon. In the case of the multiple-layer flow casting, no limitation is posed upon the thickness of the inner side layer or the outer side layer. However, the outer side has a thickness of preferably 1 to 50%, more preferably 2 to 30% of the entire thickness of the film.

(Flow Casting)

As the solution flow casting method, there are a method in which the prepared dope is uniformly extruded onto a metallic support from a pressurizing die, a doctor blade method in which the thickness of the dope once flow cast on a metal support is adjusted with a blade, a reverse roll coater method in which the thickness is adjusted with a reversely turning roll, etc. The pressurizing die method is preferred. The temperature of the dope used in the flow casting is preferably −10 to 55° C., more preferably 25 to 50° C. In that case, the temperature may be identical over the entire steps, or may be different in a part of the steps. When the temperature differs, the temperature is preferably at a desired level immediately before the flow casting.

(Drying)

In order to dry the dope on the metallic support in the production of the film, there are generally a method in which hot air is blown upon a front surface side of the metallic support (for example, the drum or the band), that is, hot air is blown upon a front surface of the web on the metallic support, a method in which hot air is blown upon a back surface of the drum or band, a liquid heat conduction method in which a temperature-controlled liquid is brought into contact with a back surface opposite to the dope flow casting surface of the band or drum so that the surface temperature may be controlled by heating the drum or band through heat conduction, etc. The back surface liquid heat conduction system is preferable. The temperature of the surface of the metallic support before the flow casting may be any level, so long as the surface temperature is not more than the boiling point of a solvent used in the dope. However, in order to accelerate the drying or take away the flowability of the dope on the metallic support, it is preferable that the surface temperature is set lower, by 1 to 10° C., than the boiling point of a solvent having the lowest boiling point among the solvents used. However, the above is not applicable when the flow cast dope is cooled and peeled without being dried.

(Peeling)

When a half dried film is peeled from the metallic support and if the peeling resistance (peeling load) is large, the film is irregularly stretched in the film-forming direction to cause optically anisotropic unevenness. Particularly when the peeling load is large, stretched portions and non-stretched portions are stepwise and alternatively formed in the film-forming direction, so that a distribution in the retardation occurs. When such a film is mounted on a liquid crystal display device, a linear or a band-like unevenness comes to appear. In order to prevent the occurrence of such a problem, it is preferably to set a peeling load upon the film at not more than 0.25N per a film-peeling width of 1 cm. The peeling load is more preferably not more than 0.2 N/cm, more preferably not more than 0.15 N/cm, and particularly preferably not more than 0.10 N/cm. The peeling load is particularly preferably not more than 0.2N/cm, because unevenness based on the peeling is not observed at all in this range even in the case of a liquid crystal display device which would be likely to develop unevenness. As a method for reducing the peeling load, there are a method in which the peeling agent is added as mentioned above and a method in which the composition of the solvent to be used is selected. A preferable concentration of the residual volatile components at the time of peeling is 5 to 60 mass %, more preferably 10 to 50 mass %, particularly preferably 20 to 40 mass %. It is preferable to peel the film in a state with a high concentration of the volatile components, because the drying speed is increased to raise the productivity. On the other hand, since the film has small strength and elasticity in the state with the high concentration of the volatile components, it will be cut or elongated by the peeling force. In addition, the peeled film has a poor self-sustaining force, so that it is likely to be deformed, get wrinkled and cause knicks. Further, this causes a distribution in the retardation.

(Stretching)

When the film produced by the above solution film-forming method is further stretched, it is preferable to stretch the film in the state that the solvent still sufficiently remains in the film immediately after peeling. Stretching is performed to (1) obtain the film having excellent flatness free from wrinkle and deformation and (2) increase an in-plane retardation. When the film is stretched for the purpose of (1), stretching is performed at a relatively high temperature and a low stretching magnification of 1% to 10% at the most. Stretching at 2 to 5% is particularly preferable. When the film is stretched for the purpose of both (1) and (2) or (2) only, stretching is performed at a relatively low temperature and a stretching magnification is preferably 1 to 200%, more preferably lto 100%, further more preferably 10 to 70%.

The film may be stretched uniaxially in a vertical or lateral direction only or may be stretched biaxially simultaneously or subsequently. The birefringence of a retardation film for a VA liquid crystal cell or an OCB (Optically Compensatory Bend) liquid crystal cell is preferably such that the refractive index in the width direction is greater than that in a longitudinal direction. Therefore, the film is preferably stretched more largely in the width direction.

Although the thickness of the finished (dried) film of the present invention varies depending upon the use purpose, it is ordinarily in a range of 20 to 500 μm, preferably in a range of 30 to 150 μm. Particularly, the thickness is preferably 40 to 110 μm for the liquid crystal display device.

[Characteristics of the Films]

Preferable optical characteristics of the films of the present invention are different depending upon applications of the films, and are preferably appropriately adjusted.

In the following, preferred ranges of in-plane retardation values (Re) and thickness retardation values (Rth) are shown for respective applications. The in-plane retardation values (Re) and the thickness retardation values (Rth) in the present specification were measured at a measurement wavelength of 590 nm, unless particularly specified.

When the film is used as a protective film in a polarizing plate, Re satisfies preferably 0 nm≦Re≦5 nm, and more preferably 0 nm≦Re≦3 nm, whereas Rth satisfies preferably 0 nm≦Rth≦50 nm, more preferably 0 nm≦Rth≦35 nm, particularly preferably 0 nm≦Re≦10 nm.

When the film is used as a retardation film, the Re range and the Rth range vary. Although there are a variety of needs depending upon the kinds of the films, 0 nm≦Re≦100 nm and 0 nm≦Rth≦400 nm are preferable. It is more preferable that 0 nm≦Re≦20 nm and 40 nm≦Rth≦80 nm for the TN mode and 20 nm≦Re≦80 nm and 80 nm≦Rth≦400 nm for the VA mode. Particularly preferable ranges in the case of the VA mode are 30 nm≦Re≦75 nm and 120 nm≦Rth≦250 nm. When compensation is made by a single retardation film, 50 nm≦Re≦75 nm and 180 nm≦Rth≦250 nm are preferable. When compensation is made by two retardation films, 30 nm≦Re≦50 nm and 80 nm≦Rth≦140 nm are preferable. They correspond to a preferable embodiment from the standpoint of dependency of color shift and contrast upon viewing angles at the time of performing black display in the compensation film of the VA mode.

Desired optical characteristics of the film of the present invention can be realized by appropriately adjusting process conditions such as the copolymerizing ratio, the kinds and the addition amounts of the additives, the stretching magnification, the content of the residual volatile components on peeling, etc.

In the description, Re(λ) and Rth(λ) each indicate the in-plane retardation and the thickness direction retardation of the film at a wavelength λ. Re(λ) is measured by applying a light having a wavelength of λ nm in the normal direction of the film, using KOBRA-21ADH or WR (by Oji Scientific Instruments).

When the film tested is represented by a monoaxial or biaxial index ellipsoid, then its Rth(λ) is computed according to the method mentioned below.

With the in-plane slow axis (judged by KOBRA 21ADH or WR) taken as the inclination axis (rotation axis) of the film (in case where the film has no slow axis, the rotation axis of the film may be in any in-plane direction of the film), Re(λ) of the film is measured at 6 points in all thereof, from −50° to +50° relative to the normal direction of the film at intervals of 10°, by applying a light having a wavelength of λ nm from the inclined direction of the film. Based on the thus-determined retardation data of Re(λ), the mean refractive index and the inputted film thickness, Rth(λ) of the film is computed with KOBRA 21ADH or WR.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be computed according to the following formulae (3) and (4):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 3 )$$

[wherein Re(θ) means the retardation value of the film in the direction inclined by an angle θ from the normal direction; nx means the in-plane refractive index of the film in the slow axis direction; ny means the in-plane refractive index of the film in the direction vertical to nx; nz means the refractive index of the film vertical to nx and ny].
Rth=((nx+ny)/2−nz)×d. (4):

When the film to be tested could not be represented by a monoaxial or biaxial index ellipsoid, or that is, when the film does not have an optical axis, then its Rth(λ) may be computed according to the method mentioned below.

With the in-plane slow axis (judged by KOBRA 21ADH or WR) taken as the inclination axis (rotation axis) of the film, Re(λ) of the film is measured at 11 points in all thereof, from −50° to +50° relative to the normal direction of the film at intervals of 10°, by applying a light having a wavelength of λ nm from the inclined direction of the film. Based on the thus-determined retardation data of Re(λ), the mean refractive index and the inputted film thickness, Rth(λ) of the film is computed with KOBRA 21ADH or WR.

In the above measurements, values in Polymer Handbook (JOHN WILEY & SONS, INC.) and catalogues of various optical films can be used as assumed values of the average refractive indexes. As to the films having no known average refractive indexes, the average refractive indexes can be measured by an Abbe refractometer. The average refractive indexes of principal optical films are recited by example as follows: cellulose acylate (1.48), cycloolefin polymer (1.52), polycarbonate (1.59), polymethyl methacrylate (1.49) and polystyrene (1.59). When assumed values of these average refractive indexes and the thicknesses of the films are inputted, KOBRA 21ADH or WR calculates nx, ny and nz. Nz=(nx−nz)/(nx−ny) is further calculated from the nx, the ny and nz calculated above.

Further, when the film of the present invention is used as the protective film for the polarizing plate, it is preferable that an optical elasticity value is 0.5×10⁻¹³ to 9.0×10⁻¹³ [cm²/dyn], and a moisture permeation value (value calculated by converting the film thickness to 80 μm) is preferably 180 to 435 [g/cm²24 h]. The optical elasticity value is more preferably 0.5×10⁻¹³ to 7.0×10¹³ [cm²/dyn], further preferably 0.5×10⁻¹³ to 5.0×10⁻¹³ [cm²/dyn]. Meanwhile, the moisture permeation value (value obtained when the thickness of the film is converted to 80 μm) is more preferably 180 to 400 [g/cm²24 h], further preferably 180 to 350 [g/cm²24 h]. When the film of the present invention has the above characteristics and is used as the protective film for the polarizing plate, reduction in performances due to the influence of the temperature can be decreased.

[Polarizing Plates]

The polarizing plate of the present invention comprises at least the film of the invention and a polarizing film. Ordinarily, the polarizing plate comprises the polarizing film and two protective films disposed on its both sides. The film of the present invention can be used for both or one of these protective films. As another protective film, an ordinary cellulose acetate film or the like may be used. As the polarizing film, there are an iodine-based polarizing film, a dye-based polarizing film using a dichroic dye, and a polyene-based polarizing film. The iodine-based polarizing film and the dye-based polarizing film are generally produced by using polyvinyl alcohol-based films. When the film of the present invention is used as the protective film for the polarizing plate, the film is subjected to a surface treatment as mentioned later, and then the treated surface of the film is bonded to the polarizing film by using an adhesive. As the adhesive used, polyvinyl alcohol-based adhesives such as polyvinyl alcohol, polyvinyl butylal, etc., vinyl-based latexes such as butyl acrylate, gelatin, etc. are recited, for example. The polarizing plate is constituted by the polarizing film and the protective films protecting both of the surfaces thereof, and further a protective film is laminated on one surface of the polarizing plate, and a separation film is laminated on the opposite surface. The protective film and the separation film are used for protecting the polarizing plate at the times of the delivering of the polarizing plate, inspecting the product, etc. In this case, the protective film is laminated to protect the surface of the polarizing plate, and used at one surface opposite to another at which the polarizing plate is to be bonded to a liquid crystal plate. Further, the separation film is used for covering an adhesive layer bonded to the liquid crystal plate, and used at a side of the surface at which the polarizing plate is to be bonded to the liquid crystal plate. It is preferable that the film of the present invention is bonded to the polarizing film, while the transmitting axis of the polarizing film is in conformity with the retardation phase axis of the film.

(Surface Treatment of Films)

In the present invention, the surface of the film is preferably treated to improve the adhesion between the polarizing film and the protective film. Any surface treating method may be used, so long as it can improve the adhesion. As a preferable surface treating method, a glow discharge treatment, an ultraviolet ray irradiation treatment, a corona treatment and a flame treatment are recited, for example. The glow discharge treatment recited here means a treatment with a so-called low temperature plasma occurring under a low gas pressure. In the present invention, plasma treatment under the atmospheric pressure is also preferred. Details of the glow discharge treatments other than the above are described in U.S. Pat. No. 3,462,335, U.S. Pat. No. 3,761,299, U.S. Pat. No. 4,072,769 and British Patent No. 891,469. Further, a method described in JP-A S59-556,430 is also used, in which after discharging is started, a discharge atmosphere gas composition is only a gas species generated in a container when a polyester support itself is treated with the discharging. Furthermore, a method described in JP-B S60-16614 is also used, in which when glow discharge treatment is to be performed in vacuum, discharging is effected in the state that the surface temperature of the film is set at 80° C. to 180° C.

Although a preferred range of the degree of the surface treatment differs depending upon the kind of the surface treatment, it is preferable that the surface treatment results in a contact angle between the treated surface of the protective film and pure water being less than 50°. The above contact angle is more preferably not less than 25° and less than 45°. When the contact angle between the surface of the protective film and pure water is in the above range, the adhesion strength between the protective film and the polarizing film becomes good.

(Adhesive)

When the polarizing film made of the polyvinyl alcohol and the surface-treated film of the present invention are bonded together, an adhesive containing a water-soluble polymer is preferably used. As the water-soluble polymer preferably used in the above adhesive, mention may be made of homopolymers or copolymers composed of, as constituent elements, ethylenic unsaturated monomers such as N-vinyl pyrrodidone, acrylic acid, methacrylic acid, maleic acid, β-hydroxyethyl acrylate, β-hydroxyethyl methacrylate, vinyl alcohol, methylvinyl ether, vinyl acetate, acrylamide, methacrylamide, diacetone acrylamide, vinylimidazole, etc., polyoxyethylene, polyoxypropylene, poly-2-methyloxazoline, methyl cellulose, hydroxyethyl cellulose, hydroxypropyl cellulose gelatin, etc. In the present invention, PVA and gelatin are preferred among them. The thickness of the adhesive layer is preferably 0.01 to 5 μm, more preferably 0.05 to 3 μm after drying.

(Antireflection Layer)

It is preferable to dispose a functional film such as an antireflection layer or the like on the protective film of the polarizing plate located on the opposite side of the liquid crystal cell. Particularly, the present invention favorably uses an antireflection layer composed of at least a light scattering layer and a layer of a low refractive index laminated on the protective film in this order or an antireflection layer composed of a medium refractive index layer, a high refractive index layer and a low refractive index layer laminated on the protecting layer in this order.

(Light Scattering Layer)

The light scattering layer is formed to afford upon the film a light scattering property based on surface scattering and/or interior scattering and a hard coat property to improve abrasion resistance of the film. Therefore, the light scattering layer is formed by incorporating a binder to provide the hard coat property, matting particles to provide the light scattering property, and if necessary an inorganic filler to increase the refractive index, prevent crosslinking shrinkage and raise the strength. The thickness of the light scattering layer is preferably 1 to 10 μm, and more preferably 1.2 to 6 μm from the standpoint of affording the hard coat property and from the standpoint of suppressing the occurrence of curling and progression of brittleness.

(Layers Other than the Antireflection Layer)

In addition, a hard coat layer, a front scattering layer, a primer layer, an antistatic layer, an undercoat layer, a protective layer, etc. may be provided.

(Hard Coat Layer)

The hard coat layer is provided on the surface of the support to afford a physical strength upon the protective layer on which the antireflection layer is provided. Particularly, the hard coat layer is preferable provided between the support and the above high refractive index layer. The hard coat layer is preferably formed by a crosslinking reaction or a polymerization reaction of a photocurable and/or thermosetting compound. As a curable functional group, a photopolymerizable functional group is preferable, and an organic metal compound containing a hydrolyzable functional group is preferably an organic alkoxy silyl compound.

(Antistatic Layer)

When the antistatic layer is provided, it is preferable that electroconductivity with a volume resistivity of not more than 10⁻⁸ (Ωcm⁻³) is imparted thereto. Although it is possible to impart the volume resistivity of not more than 10⁻⁸(Ωcm⁻³) by using a moisture-absorbable material, a water-soluble inorganic salt, a certain kind of a surface active agent, a cation polymer, an anion polymer, colloidal silica or the like, there are problems that dependency upon the temperature and the humidity is large and sufficient conductivity cannot be ensured at a low humidity. For this reason, a metal oxide is preferred as the material for the electroconductive layer.

[Liquid Crystal Display Device]

The film of the present invention, a retardation film made of that film and a polarizing plate using that film can be used in liquid crystal cells of various display modes and liquid crystal display devices. There are proposed various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic). Among them, the films of the present invention can be favorably used for the OCB mode and the VA mode.

### EXAMPLES

In the following, the present invention will be explained more concretely by reciting examples. Materials, use amounts, ratios, treating contents, treating procedures, etc. shown in the following examples can be appropriately varied unless no deviation occurs from the purpose of the present invention. Therefore, the scope of the present invention is not limited to the specific examples shown below.

[Synthesis of Norbornene-Based Compounds]

Among starting materials for the norbornene-based polymers to be used in the present invention, 5-norbornene-2-yl-acetate (M-1) and norbornene (NB) are commercially available from Aldrich Corporation. M-1 was purified by simple distillation before use.

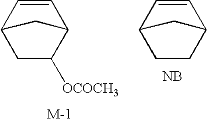

Other norbornene-based compounds were synthesized according to the following synthesis examples.

### Synthesis Example 1

Norborneneol (manufactured by Aldrich Corporation) 220.3 g, 166.1 g of pyridine (manufactured by Wako Pure Chemical Industries, Ltd.), 332.2 g of butyric anhydride (manufactured by Wako Pure Chemical Industries, Ltd.) and 200 mL of ethyl acetate were charged into a flask, which were stirred at 60° C. for 5 hours. The mixture obtained was put into ice water, and subjected to separating extraction. An organic layer was dried over magnesium sulfate, which was filtered off. The filtrate was evaporated and distilled under reduced pressure. Thereby, a colorless norbornene-based compound (M-2) was obtained.

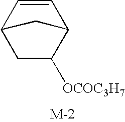

### Synthesis Example 2

The following norbornene-based compound (M-3) was obtained in the same synthesis method as in Example 1, except that hexanoic anhydride (manufactured by Wako Pure Chemical Industries, Ltd.) was charged instead of butyric anhydride.

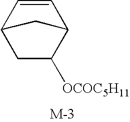

### Synthesis Example 3

Dicyclopentadiene (manufactured by Wako Pure Chemical Industries, Ltd.) 1094 g, 1772 g of allyl acetate (manufactured by Wako Pure Chemical Industries, Ltd.), and 1 g of hydroquinone (manufactured by Wako Pure Chemical Industries, Ltd.) were charged into an autoclave, and a space was replaced by nitrogen. The mixture was stirred at an interior temperature of 180° C. for 6 hours in a sealed system. The reaction mixture was filtered, and a volatile component was evaporated. The residue was distilled under reduced pressure, thereby obtaining a colorless transparent norbornene-based compound (M-4).

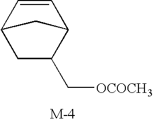

### Synthesis Example 4

A norbornene-based compound (M-5) was obtained in the same procedure as in Example 3, except that allyl acetate in Synthesis Example 3 was replaced by allyl butyrate (manufactured by Aldrich Corporation).

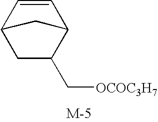

### Synthesis Example 5

A norbornene-based compound (M-6) was obtained in the same procedure as in Example 3, except that allyl acetate in Synthesis Example 3 was replaced by allyl hexanoate (manufactured by Wako Pure Chemical Industries, Ltd.)).

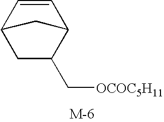

### Synthesis Example 6

Dicyclopentadiene (manufactured by Wako Pure Chemical Industries, Ltd.) 396.6 g, 312.5 g of styrene (manufactured by Wako Pure Chemical Industries, Ltd.) and 1 g of hydroquinone (manufactured by Wako Pure Chemical Industries, Ltd.) were charged into an autoclave, and a space was replaced by nitrogen. The mixture was stirred at an interior temperature of 180° C. for 6 hours in a sealed system. The residue was subjected to distillation under reduced pressure, thereby obtaining a colorless transparent norbornene-based compound (M-7). 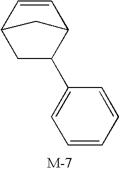
[Synthesis of Norbornene-Based Polymers]

### Synthesis Example 7

Purified toluene 130 mL and 119 g of the above norbornene-based compound (M-1) were placed into a reaction container. Then, 48 mg of palladium acetylacetonate (manufactured by Tokyo Chemical Industry Co., Ltd.) dissolved in 10 mL of toluene, 46 mg of tricyclohexyl phosphine (Strem Chemicals, Inc.) and 256 mg of dimethyl anilium-tetrakispentafluoro-phenylborate Strem Chemicals, Inc.) dissolved in 10 mL of methylene chloride were charged into a reaction container. The mixture began to be heated, and was stirred at 90° C. for 6 hours. During this step, toluene was appropriately added, following increase in the viscosity of the reaction solution. Then, 10 mL of 1-hexene (manufactured by Wako Pure Chemical Industries, Ltd.) was added dropwisely, and the resultant was further reacted for one hour. The obtained reaction solution was put into excess methanol, thereby precipitating a norbornene-based polymer (P-1). The precipitate was collected, and washed with methanol. The obtained norbornene-based polymer (P-1) was dried in vacuum at 110° C. for 6 hours.

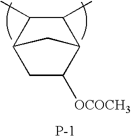

### Synthesis Example 8

A norbornene-based polymer (P-2) was obtained by synthesizing in the same manner as in Synthesis Example 7, except that the norbornene-based compound (M-1) was replaced by the same molar quantity of the norbornene-based compound (M-2).

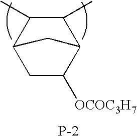

### Synthesis Example 9

A norbornene-based polymer (P-3) was obtained by synthesizing in the same manner as in Synthesis Example 7, except that the norbornene-based compound (M- 1) was replaced by the same molar quantity of the norbornene-based compound (M-3).

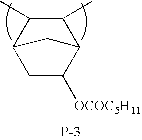

### Synthesis Example 10

A norbornene-based polymer (P-4) was obtained by synthesizing in the same manner as in Synthesis Example 7, except that the norbornene-based compound (M-1) was replaced by the same molar quantity of the norbornene-based compound (M-4).

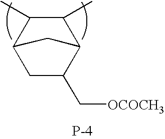

### Synthesis Example 11

A norbornene-based polymer (P-5) was obtained by synthesizing in the same manner as in Synthesis Example 7, except that the norbornene-based compound (M-1) was replaced by the same molar quantity of the norbornene-based compound (M-5).

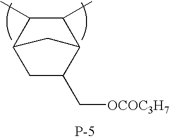

### Synthesis Example 12

A norbornene-based polymer (P-5) was obtained by synthesizing in the same manner as in Synthesis Example 7, except that the norbornene-based compound (M- 1) was replaced by the same molar quantity of the norbornene-based compound (M-6).

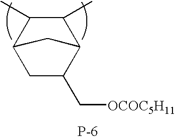

### Synthesis Example 13

A norbornene-based polymer (P-7) was obtained by synthesizing in the same manner as in Synthesis Example 7, except that the norbornene-based compound (M-1) was replaced by the same molar quantity of the norbornene-based compound (M-6) and 18.4 g of the norbornene-based compound (NB). An analysis result with ¹HNMR revealed that the compounding ratio between the norbornene-based compound (NB) and the norbornene-based compound (M-6) in the copolymer was 21/79 (molar ratio).

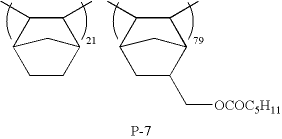

### Synthesis Example 14

A norbornene-based polymer (P-8) was obtained by synthesizing in the same manner as in Synthesis Example 7, except that the norbornene-based compound (M-1) was replaced by the same molar quantity of the norbornene-based compound (M-6) and 33.3 g of the norbornene-based compound (M-7). An analysis result with ¹HNMR revealed that the compounding ratio between norbornene-based compound (M-7) and the norbornene-based compound (M-6) in the copolymer was 23/77 (molar ratio). 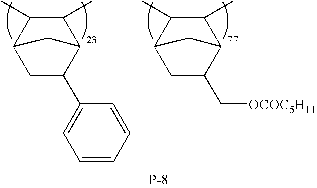
(Analysis Results)

Each of the norbornene-based polymers (P-1) to (P-8) obtained above was dissolved in tetrahydrofuran, and the molecular weight (on styrene conversion) was measured by a gel permeation chromatograph. Further, the glass transition temperature was measured with DSC6200 of Seiko Epson Corporation.

Results are shown in Table 1.

TABLE 1

| | Polymer | Mw | Mn | Tg[° C.] |
|---|---|---|---|---|
| Synthesis Example 7 | P-1 | 213400 | 74300 | 330 |
| Synthesis Example 8 | P-2 | 180500 | 65300 | 270 |
| Synthesis Example 9 | P-3 | 163200 | 52100 | 175 |
| Synthesis Example 10 | P-4 | 381000 | 92000 | 300 |
| Synthesis Example 11 | P-5 | 386600 | 102300 | 245 |
| Synthesis Example 12 | P-6 | 237500 | 71500 | 140 |
| Synthesis Example 13 | P-7 | 384000 | 120600 | 205 |
| Synthesis Example 14 | P-8 | 345000 | 109000 | 240 |

### Example 1

### Production of Polymer Films and Measurements of Film Characteristics

(Production of Films)

A dope was obtained by dissolving 50 g of each of the norbornene-based polymers (P-1) to (P-8) obtained above in 300 to 450 g of methylene chloride, and the dope having an appropriate viscosity was filtered under pressure. A film was produced by flow-casting the obtained dope on a hydrophobic glass plate having an A3 size by using an applicator. The film was dried at 25° C. for 1 minutes in a sealed system, and continuously dried at 70° C. for 10 minutes in an air blow dryer. The film was peeled from the glass plate, and pinched in a stainless frame. The resultant was dried at 100° C. for 30 minutes in the dryer and at 133° C. for 30 minutes in the dryer. Thereby, transparent films (F-1) to (F-8) were obtained.

(Stretching)

Each of the transparent films (F-1) to (F-8) was cut into a size of 5 cm long×5 cm wide. This was stretched at a stretching temperature and a stretched ratio given in Table 2 by using an automatic stretcher manufactured by Imoto Seisakujo co., Ltd., thereby obtaining stretched films (EF-1) to (EF-22).

(Measurement of Physical Properties)

It was visually judged whether the stretched films (EF-1) to (EF-22) were yellowish or not. Further, retardation values were measured at the wavelength of 590 nm as mentioned above. The thickness “d” of the film was obtained by averaging thicknesses of arbitrary three points, which were measured by a digital micrometer. An Re value at a film thickness of 80 μm was determined by the following formula.
Re=(Measured retardation/d)×80

The stretching conditions and evaluation results regarding the Re were summarized in Table 2 with respect to the stretched films (EF-1) to (EF-22) produced above. Since the stretched films (EF-1, 2, 10 and 11) were broken, no retardation was measured. In Table 2, “◯” means that a film changed yellowish.

TABLE 2

| | | Stretching | Stretched | | | |
|---|---|---|---|---|---|---|
| Stretched | | temperature | ratio | yellowish | Re | |
| Film | Film | [° C.] | [%] | changing | [nm] | |
| EF-1 | F-1 | 330 | 10 | ◯ | breaking | Comparative Example |
| EF-2 | F-1 | 240 | 10 | X | breaking | Comparative Example |
| EF-3 | F-2 | 240 | 10 | X | 57 | Example |
| EF-4 | F-2 | 240 | 20 | X | 100 | Example |
| EF-5 | F-2 | 240 | 50 | X | 230 | Example |
| EF-6 | F-3 | 180 | 10 | X | 68 | Example |
| EF-7 | F-3 | 180 | 50 | X | 105 | Example |
| EF-8 | F-3 | 180 | 70 | X | 256 | Example |
| EF-9 | F-4 | 300 | 10 | ◯ | 75 | Comparative Example |
| EF-10 | F-4 | 300 | 20 | ◯ | breaking | Comparative Example |
| EF-11 | F-4 | 240 | 10 | X | breaking | Comparative Example |
| EF-12 | F-5 | 240 | 10 | X | 63 | Example |
| EF-13 | F-5 | 240 | 30 | X | 173 | Example |
| EF-14 | F-5 | 240 | 50 | X | 300 | Example |
| EF-15 | F-6 | 150 | 10 | X | 71 | Example |
| EF-16 | F-6 | 150 | 50 | X | 310 | Example |
| EF-18 | F-6 | 150 | 70 | X | 415 | Example |
| EF-19 | F-7 | 205 | 10 | X | 49 | Example |
| EF-20 | F-7 | 205 | 30 | X | 160 | Example |
| EF-21 | F-8 | 240 | 10 | X | 78 | Example |
| EF-22 | F-8 | 240 | 30 | X | 237 | Example |

As shown from the results in Table 2, the films of the present invention can be stretched at lower temperatures and high stretched ratios without being changed yellowish, as compared with films in Comparative Examples. On the other hand, it is necessary to stretch the films of the Comparative Examples at temperatures of not less than 300° C. Even when the films can be stretched, they become yellowish themselves. If they are stretched at a relatively low temperature, they are broken.

### Example 2

### Production and Evaluation of Polarizing Plates

The oriented film (EF-3) produced above and a commercially available cellulose acylate film (manufactured by Fuji Photo Film Co., Ltd., Fuji TAC) was immersed in a 1.5 N aqueous solution of sodium hydroxide at 60° C. for 2 minutes. Then, after they were immersed in a 0.1 N aqueous solution of sulfuric acid for 30 seconds, they were passed through a water washing bath, thereby obtaining a saponified stretched film (EF-3) and a saponified Fuji TAC.

A polarizing film was obtained by longitudinally stretching a 75 μm-thick polyvinyl alcohol film (manufactured by Kuraray Co., Ltd., 9X75RS) according to Example 1 of JP-A 2001-141926, while different peripheral velocities were given to two pairs of nipple rolls.

In order that a laminated structure of “the saponified EF-3/the polarizing film/the saponified Fuji TAC” might be obtained while the film-longitudinal direction being set at 45°, the polarizing film and the saponified oriented films (EF-3) thus obtained were bonded together by using a 3 wt % aqueous solution of polyvinyl alcohol (manufactured by Kuraray Co., Ltd., PVA-117H) as an adhesive.

Thereby, a polarizing plate (Pol-1) was produced. The bonded state was good, and no warping and the like were observed after drying.

Polarizing plates were produced in the same manner as mentioned above by using the oriented films (EF-4 to EF-8) and the oriented films (EF-12 to EF-22), respectively. The bonded state of each of them was good, and no warping and the like were observed after drying.

The present disclosure relates to the subject matter contained in Japanese Patent Application No. 206118/2006 filed on Jul. 28, 2006, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A film comprising norbornene-based polymer having a repeating unit represented by the following formula (1): 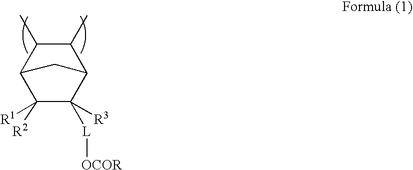
wherein L represents a single bond or an alkylene group having 1 to 10 carbon atoms, R represents alkyl group having 2 to 10 carbon atoms, R¹, R² and R³ each represent a hydrogen atom or a substituent group.

2. The film according to claim 1, wherein L is a single bond or a methylene group (—CH₂—).

3. The film according to claim 1, wherein R is an alkyl group having 3 to 6 carbon atoms.

4. The film according to claim 1, at least one of R¹, R² and R³ is a hydrogen atom.

5. The film according to claim 1, all of R¹, R² and R³ are a hydrogen atom.

6. The film according to claim 1, the norbornene-based polymer is a homopolymer.

7. The film according to claim 1, the number average molecular weight of the norbornene-based polymer is 10,000 to 1,000,000.

8. A retardation film comprising the film according to any one of claims 1 to 7.

9. The retardation film according to claim 8, which meets the following formula (1):
0≦Re≦400 nm (1)
wherein Re represents a retardation (Re) values at wavelengths of 590 nm.

10. A polarizing plate comprising a polarizer and the film according to any one of claims 1 to 7.

11. A Liquid crystal display comprising the film according to any one of claims 1 to 7.
